(19) United States
(12) Patent Application Publication
(10) Pub. No.: US 2026/0349146 A1
(43) Pub. Date: Nov. 5, 2026

(54) Polyurethane Light-Reflective Film and Light-Reflective Sheet and Article having the Light-Reflective Sheet

(71) Applicant: CHIMERA MULTINATIONAL CO., LTD., Taipei City (TW)

(72) Inventor: Ming-Hsien YAO, Taipei City (TW)

(21) Appl. No.: 19/656,068

(22) Filed: Apr. 23, 2026

(30) Foreign Application Priority Data
May 2, 2025 (TW) 114116613

(51) Int. Cl. G02B 1/04; G02B 5/08

(52) U.S. Cl. CPC G02B 1/04; G02B 5/0808

(57) ABSTRACT

The invention provides a polyurethane light-reflective film, a light-reflective sheet, and an article having the light-reflective sheet. The light-reflective film has a base layer, a light-reflective layer, and a polyurethane layer, the polyurethane layer is a surface layer of the light-reflective film, and the light-reflective layer is an inner layer of the light-reflective film. The polyurethane layer is removable, exposing the light-reflective layer at at least one position where at least a part of the polyurethane layer is removed, forming at least one light-reflective part. The light-reflective sheet is formed by cutting the light-reflective film and can be disposed on a surface of an article, providing the article with a light-reflective function.

### FIELD OF THE INVENTION

The invention relates to a film material, and more specifically, to a light-reflective film in which a light-reflective layer is located within the film material. The invention also relates to a light-reflective sheet made from the light-reflective film, and an article having the light-reflective sheet.

### DESCRIPTION OF THE RELATED ART

Adhering light-reflective materials to clothing or wearables can improve safety during nighttime activities, examples include light-reflective tapes and light-reflective strips.

Conventional light-reflective materials have their light-reflective elements located on an outer surface of the light-reflective materials, and are not disposed or hidden inside the light-reflective materials.

A shape of an outline of a conventional light-reflective material is its light-reflective pattern; that is, a shape of the light-reflective material is its light-reflective pattern, and there is nothing special about it.

Conventional light-reflective materials are monochromatic and cannot display a plurality of colors, resulting in a monotonous exterior. In terms of an exterior of an article, conventional light-reflective materials can not enhance an aesthetic appeal of the article.

Conventional light-reflective materials, due to their outer surfaces being light-reflective elements, it is difficult to bond outer surfaces of conventional light-reflective materials with other articles. Therefore, conventional light-reflective materials can only be used on a surface of articles and cannot be used or disposed on areas of articles that bear acting force.

Furthermore, conventional light-reflective materials cannot be adhered between two articles because it is difficult to bond their light-reflective surfaces with other articles. Moreover, conventional light-reflective materials are not resistant to bending, abrasion, or washing with water, thus limiting their applications.

### SUMMARY OF THE INVENTION

The invention aims to address the drawbacks mentioned above. One object of the invention is to provide a polyurethane light-reflective film and a light-reflective sheet made from the light-reflective film, a light-reflective layer of the light-reflective film is an inner layer of the light-reflective film, not an outer layer (surface layer) of the light-reflective film. Remove the surface layer of the light-reflective film to exposing the light-reflective layer, which becomes a light-reflective part of the light-reflective film or the light-reflective sheet.

One object of the invention is to provide a polyurethane light-reflective film and a light-reflective sheet made from the light-reflective film, making the light-reflective film and the light-reflective sheet resistant to bending, abrasion, and washing with water.

One object of the invention is to provide a polyurethane light-reflective film and a light-reflective sheet made from the light-reflective film, enabling the light-reflective film and the light-reflective sheet to provide one light-reflective pattern or a plurality of light-reflective patterns.

One object of the invention is to provide a polyurethane light-reflective film and a light-reflective sheet made from the light-reflective film, the light-reflective sheet has an outline with a shape and the light-reflective sheet has at least one light-reflective pattern, a shape of the light-reflective pattern can be the same as or different from an outline of the light-reflective film.

One object of the invention is to provide a polyurethane light-reflective film and a light-reflective sheet made from the light-reflective film, both the light-reflective film and the light-reflective sheet have a surface layer and a light-reflective layer, a color of the surface layer and a color of the light-reflective layer of the light-reflective film or the light-reflective sheet can be a combination of different colors, making the light-reflective film or the light-reflective sheet a polychromatic configuration (multicolored configuration).

One object of the invention is to provide a polyurethane light-reflective film and a light-reflective sheet made from the light-reflective film, a strong bonding force is provided between surface layers and light-reflective layers of the light-reflective film and the light-reflective sheet, making it difficult to separate the surface layers from the light-reflective layers, enabling the light-reflective sheet to be disposed not only to a surface of an article but also disposed to positions of structural reinforcement or structural support of an article.

One object of the invention is to provide an article with the light-reflective sheet, the light-reflective sheet can be disposed to a surface of the article to provide the article with a light-reflective effect.

One object of the invention is to provide an article with the light-reflective sheet, the light-reflective sheet has a polychromatic hue (multicolored hue), enhancing an aesthetic appeal of the article.

One object of the invention is to provide an article with the light-reflective sheet, a surface layer and a light-reflective layer of the light-reflective sheet cannot be easily peeled off, and the light-reflective sheet can be disposed on a part of an article that bears an acting force.

A light-reflective film provided by the invention comprising:
a base layer;
a light-reflective layer disposed on the base layer, the light-reflective layer having light-reflective elements; and
a polyurethane layer disposed on the light-reflective layer, the material of the polyurethane layer being removable, exposing the light-reflective layer at at least one position where at least one part of the polyurethane layer being removed, forming at least one light-reflective part.

Therefore, the polyurethane layer is a surface layer of the light-reflective film, and the light-reflective layer is an inner layer of the light-reflective film, concealed within the light-reflective film. The light-reflective film can provide light-reflective function through the light-reflective part.

The invention provides a light-reflective sheet, the light-reflective sheet is made by cutting or stamping the light-reflective film, thus having a structure identical to the light-reflective film, enabling the light-reflective sheet having at least one light-reflective part, and the light-reflective sheet can be disposed on a surface of an article. Both the light-reflective film and the light-reflective sheet are resistant to bending, abrasion, and washing with water, and have a wide range of applications.

The at least one light-reflective part is at least one open part disposed on the polyurethane layer, preferably, the at least one open part has a shape, such that the light-reflective part forms at least one light-reflective pattern.

Preferably, the light-reflective layer and the polyurethane layer have a same color or different colors, when the light-reflective layer and the polyurethane layer have a same color, the light-reflective pattern is hidden in the light-reflective film or the light-reflective sheet. When the light-reflective layer and the polyurethane layer are made of different colors, the light-reflective film or the light-reflective sheet has a polychromatic hue (multicolored hue).

Preferably, a peeling force between the polyurethane layer and the light-reflective layer is between 3 and 15 kgf/1 inch width, more preferably between 3.5 and 15 kgf/1 inch width. A strong bonding force is provided between the polyurethane layer and the light-reflective layer and the polyurethane layer and the light-reflective layer cannot be easily peeled off.

Preferably, silane or/and acrylic acid is/are added to the polyurethane layer, and the polyurethane layer contacts the light-reflective elements of the light-reflective layer, achieving the above-mentioned peeling force between the polyurethane layer and the light-reflective layer.

Preferably, the polyurethane layer is formed by coating liquid polyurethane resin or thermoplastic polyurethane resin on the light-reflective layer and the polyurethane layer is bonded to the light-reflective layer.

Preferably, the polyurethane layer is pre-made and bonded to the light-reflective layer with an adhesive. Preferably, the adhesive is a polyurethane resin or an acrylic resin, and added with silane, the adhesive contacts light-reflective elements of the light-reflective layer, achieving the above-mentioned peeling force between the polyurethane layer and the light-reflective layer.

Preferably, the base layer has flexibility and is a material that is adhesive or non-adhesive. The base layer is a hot melt adhesive layer when it is adhesive; or the base layer is not adhesive and is made of leather, artificial leather, plastics or paper.

Preferably, the light-reflective sheet has a contour shape; a shape of the at least one light-reflective pattern can be the same as or different from a contour shape of the light-reflective sheet. When the light-reflective sheet and the light-reflective pattern have a same shape, the light-reflective sheet and the light-reflective pattern present a consistent aesthetic appeal.

The invention provides an article with the light-reflective sheet, the light-reflective sheet is disposed on a surface of the article and provides a light-reflective function for the article with a light-reflective part thereof.

The article of the invention has a first element and a second element combined together; the light-reflective sheet is disposed between the first element and the second element, and the at least one light-reflective part of the light-reflective sheet is exposed on the article, enabling the article to reflect light.

A bonding force between the polyurethane layer and the light-reflective layer of the light-reflective sheet of the invention is strong and the polyurethane layer and the light-reflective layer cannot be easily peeled off. Therefore, the light-reflective sheet can be directly disposed on a part of an article that bears an acting force without worrying about the polyurethane layer and the light-reflective layer separating from each other. For example, the light-reflective sheet of the invention can be disposed between a vamp and a sole of a shoe with the base layer is connected to the vamp and the polyurethane layer is connected to the sole. The light-reflective part of the light-reflective sheet is located at a position where the polyurethane layer is exposed on the sole.

Because a bonding force between the polyurethane layer and the light-reflective layer is strong and cannot be easily peeled off, the light-reflective film, the light-reflective sheet, and the article are resistant to washing with water, and the polyurethane layer and the light-reflective layer do not detach from each other.

Since the invention is capable of forming the light-reflective pattern by removing materials of the surface layer, various light-reflective patterns can be made as needed. Therefore, a shape of the light-reflective pattern of the light-reflective film and the light-reflective sheet can be flexibly varied.

### BRIEF DESCRIPTION OF DRAWINGS

FIG. 1 is a cross-sectional view of a polyurethane light-reflective film according to a first preferred embodiment of the invention.

FIG. 2 is a cross-sectional view of another polyurethane light-reflective film according to the first preferred embodiment of the invention.

FIG. 3 is a cross-sectional view of a light-reflective pattern laser-engraved on the polyurethane light-reflective film of FIG. 1.

FIG. 4 is a cross-sectional view of a light-reflective pattern laser-engraved on the polyurethane light-reflective film of FIG. 2.

FIG. 5 is a top view of the actual polyurethane light-reflective film according to the first preferred embodiment of the invention, the light-reflective film has a plurality of light-reflective patterns.

FIG. 6 shows the light-reflective patterns of the light-reflective film in FIG. 5 reflecting light.

FIG. 7 is a cross-sectional view of the polyurethane light-reflective film according to a second preferred embodiment of the invention.

FIG. 8 is a partially exploded view of FIG. 7, showing a fabrication structure of the light-reflective film of FIG. 7.

FIG. 9 shows a photograph of the polyurethane light-reflective film of the invention fabricated into a light-reflective sheet and disposing the light-reflective sheet on an article.

FIGS. 10A to 10C show three light-reflective sheets with different shapes.

FIG. 11 is a cross-sectional view along section line 11-11 of FIG. 9, showing one type of the light-reflective sheet.

FIG. 12 is generally the same as FIG. 11, showing a cross-sectional view of another type of the light-reflective sheet disposed on an article.

FIG. 13 shows an article disposed with the light-reflective sheets thereon.

FIG. 14 is a cross-sectional view along section line 14-14 of FIG. 13.

FIG. 15 shows photographs of the light-reflective sheets with different shapes.

FIG. 16 is a photograph of the light-reflective sheet with a light-reflective layer and a PU layer thereof made with a same color.

FIG. 17 is a photograph of the light-reflective pattern of the light-reflective sheet in FIG. 16 reflecting light.

### DETAILED DESCRIPTION OF THE INVENTION

The invention provides a polyurethane light-reflective film 10 (hereinafter referred to as light-reflective film or PU light-reflective film) with a light-reflective layer. The light-reflective layer is disposed inside the light-reflective film, being an inner layer, not a surface layer of the light-reflective film. By removing partial areas of the surface layer of the light-reflective film, the light-reflective layer is exposed, becoming a light-reflective part or a light-reflective pattern of the light-reflective film. The invention also provides a light-reflective sheet, formed by cutting the light-reflective film.

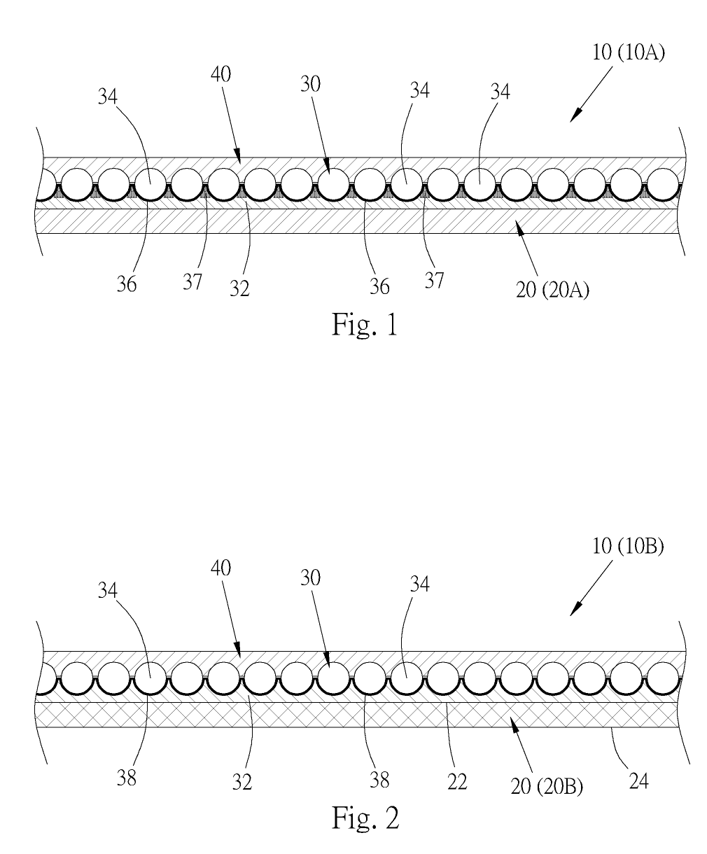

The light-reflective film is a film material. FIG. 1 shows an application example of the PU light-reflective film 10 (10A) of a first preferred embodiment of the invention, comprising: a base layer 20 (20A), a light-reflective layer 30 disposed on the base layer 20, and a surface layer disposed on the light-reflective layer 30. In a preferred embodiment of the invention, a surface layer of the light-reflective film 10 is a polyurethane layer 40, a layer made of polyurethane material, including polyurethane (PU) material or thermoplastic polyurethane (TPU) material, hereinafter referred to as the polyurethane layer (PU layer) 40.

The base layer 20 can be made of various materials, such as leather, artificial leather (superfiber PU synthetic leather), thermoplastic plastics, paper, and other flexible materials. In this application example, the base layer 20 (20A) is a layer with adhesiveness, such as an adhesive layer/a glue layer/a thermal bonding layer. In this application example, the base layer 20 is a hot melt adhesive layer 20A. The hot melt adhesive layer 20A is a hot melt adhesive material layer and can be formed from various types of hot melt adhesives, such as, but not limited to, hot melt adhesives made of polyolefin (PO), polyurethane (PU), thermoplastic polyurethane (TPU), polyamide (PA), polyethersulfone (PES), polyethylene (PE), ethylene/vinyl acetate (EVA), and rubber-based (TPR/Rubber) materials. When heated to a certain temperature, the hot melt adhesive melts into a fluid adhesive and solidifies upon cooling, resulting in fast bonding.

The light-reflective layer 30 has an adhesive layer 32 and a layer of light-reflective elements, such as a layer of tiny glass beads 34. The layer of glass beads 34 is partially embedded in the adhesive layer 32, with bottom sides (inner sides) thereof embedded in the adhesive layer 32 and top sides (outer sides) thereof exposed on the adhesive layer 32. The adhesive layer 32 can be an adhesive made of polyurethane (PU), thermoplastic polyurethane (TPU), or thermoplastic elastomer (TPE), which adheres the glass beads 34 in place. The light-reflective layer 30 is bonded to the base layer 20 (20A) by the adhesive layer 32 and covers the entire base layer 20 (20A).

The invention may use a light-reflective layer with a high light reflectance or a light-reflective layer with a moderate light reflectance. The light-reflective layer 30 shown in FIG. 1 has a high light reflectance. Bottom surfaces of the glass beads 34 are plated with a metallic plated layer 36, such as an aluminum or a silver layer, the plated layer 36 is capable of enhancing light reflection effects. The light-reflective layer 30 shown in FIG. 2 has a moderate light reflectance, and surfaces of the glass beads 34 are not provided with a plated layer.

Further, the light-reflective layer 30 can be made in various colors, such as, but not limited to, pink, green, blue, yellow, red, black, etc. There are three ways to provide the light-reflective layer 30 with color: A first way, in the light-reflective layer 30 with a high light reflectance shown in FIG. 1, a pigment or a colorant 37 is disposed between the glass beads 34 to provide the light-reflective layer 30 with a color. A second way, in the light-reflective layer 30 shown in FIG. 2, a color layer 38 is plated or coated to inner surfaces of the glass beads 34; alternatively, the color layer 38 can be plated or coated to outer surfaces of the glass beads 34, and a color of the color layer 38 becomes a color of the light-reflective layer 30. A third way is to add a dye or a pigment in the adhesive layer 32 to provide the adhesive layer 32 with a color, thereby providing the light-reflective layer 30 with a color.

The PU layer 40 exhibits excellent wear resistance and has a thin thickness, for example, 0.02~0.1 mm, preferably 0.02~0.05 mm, more preferably 0.02~0.04 mm or 0.03~0.04 mm. In the first preferred embodiment shown in FIGS. 1 and 2, the PU layer 40 is formed by coating the light-reflective layer 30 with liquid PU resin or TPU resin, and the PU layer 40 is fully coated with the reflective layer, thus bonding the PU layer 40 to the light-reflective layer 30.

Additives, such as silane or acrylic acid, or silane and acrylic acid, are added to the PU layer 40 to enhance a bonding strength between the PU layer 40 and the light-reflective layer 30. Through the silane or acrylic acid, the PU layer 40 exhibits excellent bonding property to surfaces of the glass beads 34. The silane in the PU layer 40 exhibits excellent bonding property and adhesion to both PU components of the PU layer 40 itself and the glass beads 34. The silane can hold the glass beads 34, meaning a bonding property between the silane and the glass beads 34 is excellent, making it difficult for the PU layer 40 to separate from the glass beads 34. Similarly, the acrylic acid in the PU layer 40 has the same effect.

A peeling force between the PU layer 40 and the light-reflective layer 30 is greater than 3 kgf/1 inch width, preferably greater than 3.5 kgf/1 inch width. According to the inventor's tests, a peeling force between the PU layer 40 and the light-reflective layer 30 is between 3 and 15 kgf/1 inch width, including between 3 and 11 kgf/1 inch width, preferably between 3.5 and 8 kgf/1 inch width, and more preferably between 3.5 and 7.5 kgf/1 inch width. Test conditions for a peeling force are as follows: a strip formed by bonding the PU layer 40 (1 inch wide) and the light-reflective layer 30 (1 inch wide) together is used, and the PU layer 40 and the light-reflective layer 30 are pulled in opposite directions, a pulling force must be greater than 3.5 kgf in order to separate the PU layer 40 and the light-reflective layer 30.

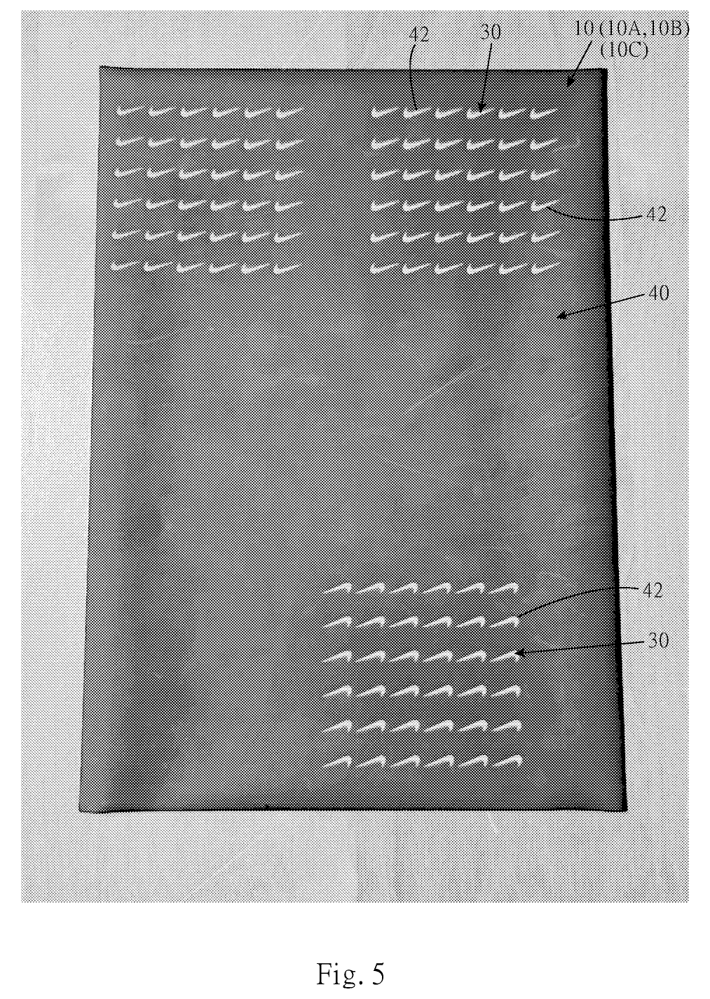

The PU layer 40 can be made to resemble leather exterior and various textures. For example, before the PU layer 40 hardens and sets, wood texture, leather texture, fiber texture, stone texture, or metal texture can be created on an outer surface of the PU layer 40 through molding or surface treatment. Furthermore, pigments or dyes are added to the PU layer 40 to create various colors, such as, but not limited to, black, green, blue, yellow, red, and pink. FIG. 5 shows a photograph of the light-reflective film 10 (10A, 10B) of FIGS. 1 and 2, where the PU layer 40 is made black, different in color from the light-reflective layer 30.

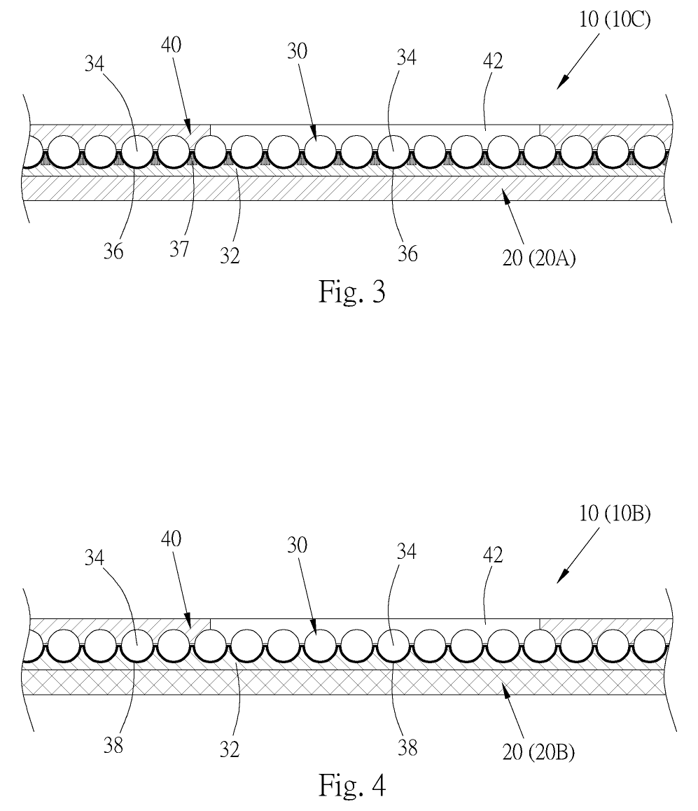

Please refer to FIG. 3, partial materials of the PU layer 40 of the PU light-reflective film 10 (10A) can be removed by an appropriate method, such as laser engraving, exposing the light-reflective layer 30 to positions where the materials are removed. For example, one pattern or a plurality of patterns (open parts) can be laser-engraved onto the PU layer 40, exposing the light-reflective layer 30 at the patterns (open parts), forming one light-reflective pattern 42 or a plurality of light-reflective patterns 42. FIG. 5 shows that the PU light-reflective film 10 (10A, 10B) has the light-reflective patterns 42 laser-engraved, and the light-reflective layer 30 is exposed at positions of the light-reflective patterns 42, providing a light-reflective effect. At positions where the light-reflective patterns 42 are not disposed, the light-reflective layer 30 remains shielded by the PU layer 40 and is not exposed.

FIG. 2 illustrates another application example of the PU light-reflective film 10 (10B) according to the first preferred embodiment of the invention, comprising: a base layer 20 (20B), a light-reflective layer 30 disposed on the base layer 20, and a polyurethane layer (PU layer) 40 disposed on the light-reflective layer 30. The light-reflective layer 30 and the PU layer 40 are the same as those in FIG. 1, and similarly, a peeling force between the light-reflective layer 30 and the PU layer 40 is between 3 and 15 kgf/1 inch width.

In this application example, the base layer 20B is a non-adhesive material, such as a polymer from leather, artificial leather, paper, or plastics. The light-reflective layer 30 is bonded to one surface 22 of the base layer 20B via the adhesive layer 32 thereof.

FIG. 4 shows that at appropriate positions on the PU light-reflective film 10 (10B), partial materials of the PU layer 40 are removed, for example, by laser-engraving one pattern or a plurality of patterns (open parts) onto the PU layer 40, exposing the light-reflective layer 30 at positions of the patterns (open parts), forming the light-reflective pattern 42 or a plurality of light-reflective patterns 42. FIG. 5 shows that the PU light-reflective film 10 (10A, 10B) is laser-engraved with the light-reflective patterns 42, and the light-reflective layer 30 is exposed at positions of the light-reflective patterns 42. At positions where the light-reflective patterns 42 are not disposed, the light-reflective layer 30 remains shielded by the PU layer 40 and is not exposed.

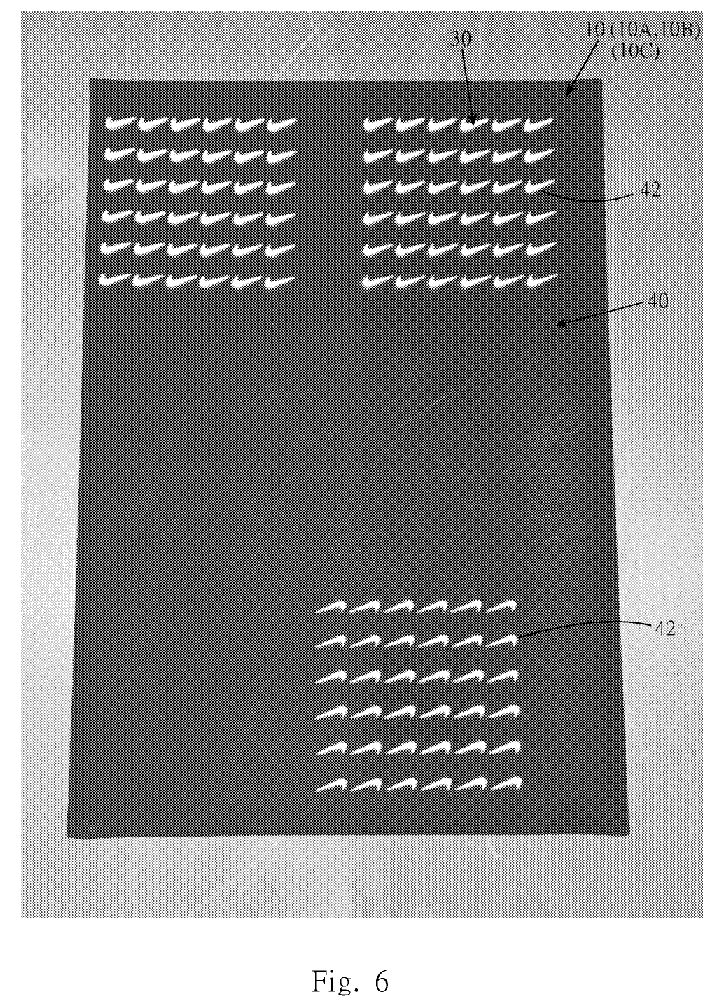

When light shines on the light-reflective patterns 42 of the light-reflective film 10 (10A, 10B), through the glass beads 34 of the light-reflective layer 30, the light-reflective patterns 42 are retroreflective, reflecting the light back to the light source, as shown in FIG. 6, creating a safety effect. Furthermore, as shown in FIGS. 5 and 6, the light-reflective film 10 (10A, 10B) is a two-color film, with the PU layer 40 and the light-reflective layer 30 thereof having different colors, which can produce a visual effect and attract attention.

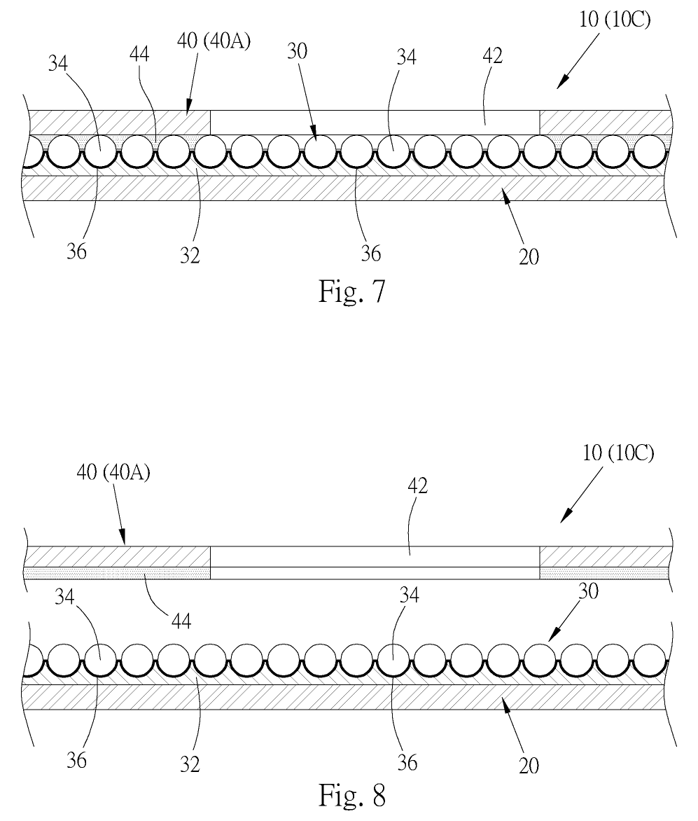

FIG. 7 shows the PU light-reflective film 10 (10C) of a second preferred embodiment of the invention, which also comprises: a base layer 20, a light-reflective layer 30 disposed on the base layer 20, and a polyurethane layer (PU layer) 40 (40A) disposed on the light-reflective layer 30. The base layer 20 can be the base layer 20 (20A, 20B) shown in FIGS. 1 or 2 . The light-reflective layer 30 is the same as the light-reflective layer 30 in the first preferred embodiment.

Please refer to FIG. 8, the PU layer 40A in this embodiment is pre-made, and by stamping or cutting to create one pattern or a plurality of patterns (open parts) to form the light-reflective patterns 42. The PU layer 40 is adhered on the light-reflective layer 30 with a layer of adhesive 44. The patterns (open parts) are formed together with the layer of adhesive 44. The layer of adhesive 44 is preferably an adhesive of polyurethane resin or acrylic resin, and added with silane. The adhesive 44 can bond well with the glass beads 34 and also with the PU layer 40A of a same polyurethane material, so that the PU layer 40A and the glass beads 34 have excellent bonding properties. A peeling force between the PU layer 40A and the light-reflective layer 30 is between 3 and 15 kgf/1 inch width.

As shown in FIG. 5, the PU light-reflective film 10 (10C) of FIG. 7, through the pre-fabricated patterns (open parts) on the PU layer 40A, also has the light-reflective patterns 42 on the PU layer 40 (40A) thereof, and the light-reflective layer 30 is exposed at positions of the light-reflective patterns 42.

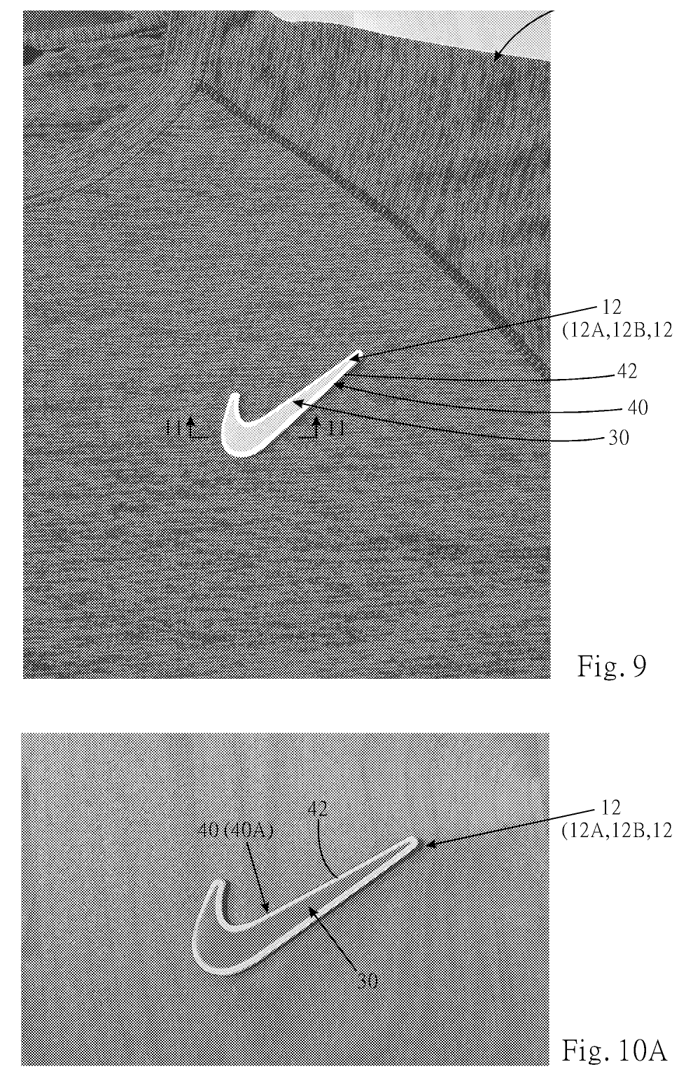

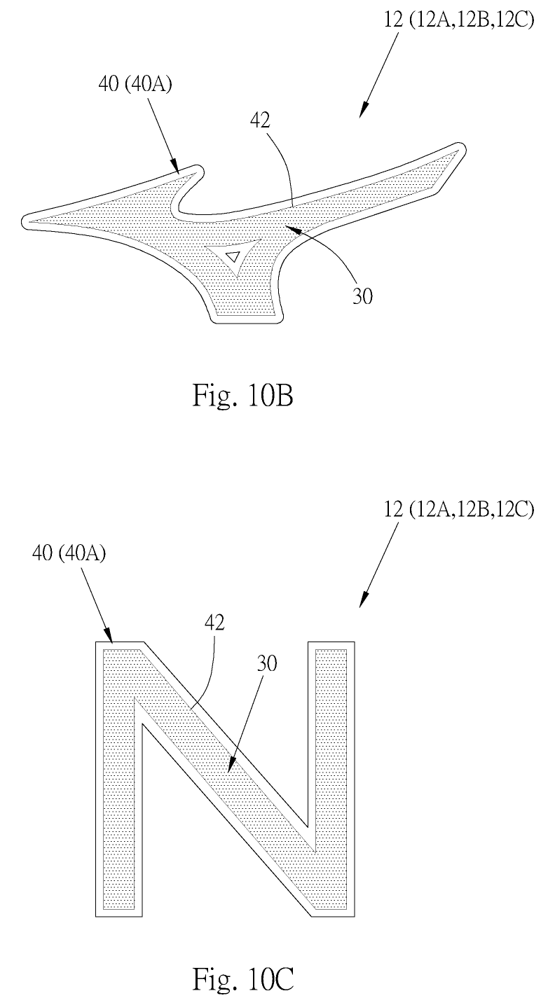

Please refer to FIG. 9, which shows a preferred embodiment of an article 50 (50A) having the PU light-reflective film 10 (10A, 10B, 10C) of the invention. The article 50A is a sportswear garment. The light-reflective film 10 is cut into light-reflective sheets (light-reflective patches) 12 (12A, 12B, 12C) of appropriate sizes and shapes or specific shapes. FIGS. 10A and 10B show the light-reflective sheets 12 with graphic shapes, while FIG. 10C shows the light-reflective sheet 12 with a text shape. The light-reflective sheet 12 or the light-reflective sheets 12 can be disposed on a surface of the article 50 (50A), so that light-reflective part of the light-reflective sheet provides a light-reflective function for the article 50 (50A). The light-reflective sheet 12 can be used on various articles, including clothing articles, accessories, or carrying devices, such as, but not limited to, apparel (clothes, trousers), socks, headscarves, headbands, gloves, shoes, bags (handbags, backpacks, etc.), boxes, etc.

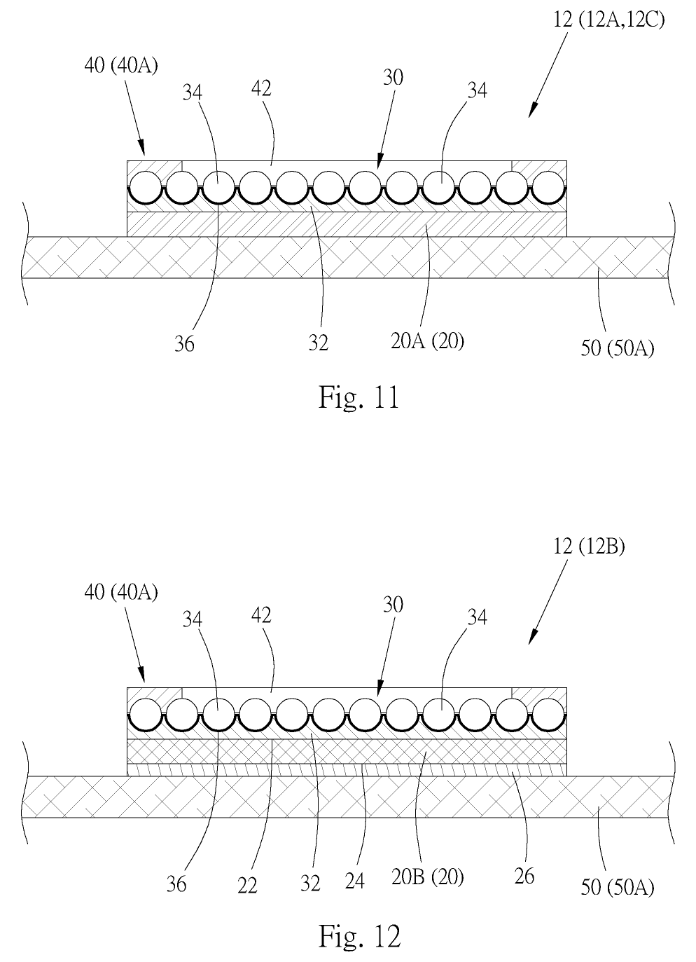

Please refer to FIG. 11. The light-reflective sheet 12 (12A, 12C) can be formed by cutting the PU light-reflective film 10 (10A, 10C) of the first and second preferred embodiments to an appropriate size, and has the hot melt adhesive layer 20A (the base layer 20), the light-reflective layer 30, and the PU layer 40 (40A), and the light-reflective pattern (open part) 42 is formed on the PU layer 40 (40A). The light-reflective sheet 12 (12A, 12C) is thermally bonded to a surface of the article 50 (50A) with the hot melt adhesive layer 20A.

Please refer to FIG. 12, which shows another light-reflective sheet 12 (12B) adhered to the article 50 (50A). The light-reflective sheet 12 (12B) can be formed by cutting the PU light-reflective film 10 (10B) of the first preferred embodiment, and has the non-adhesive base layer 20B (20), the light-reflective layer 30, and the PU layer 40 (40A), and the light-reflective pattern (open part) 42 is formed on the PU layer 40 (40A). One surface 24 of the base layer 20B of the light-reflective sheet 12 (12B) is adhered to a surface of the article 50 (50A) by an adhesive 26.

Please refer to FIGS. 9 - 10C. Each of the light-reflective sheets 12 has a contour shape, and a shape of the light-reflective pattern 42 thereof is the same as or similar to a contour shape of the light-reflective sheet 12. Meanwhile, as shown in FIGS. 9 and 10A, a color of the PU layer 40 (40A) of the light-reflective sheet 12 is not the same as a color of the light-reflective layer 30, forming a two-tone color, the light-reflective sheet 12 has a visually appealing effect on an exterior of the article 50 (50A). When a shape of the light-reflective sheet 12 and a shape of the light-reflective pattern 42 are the same, a consistent aesthetic is achieved.

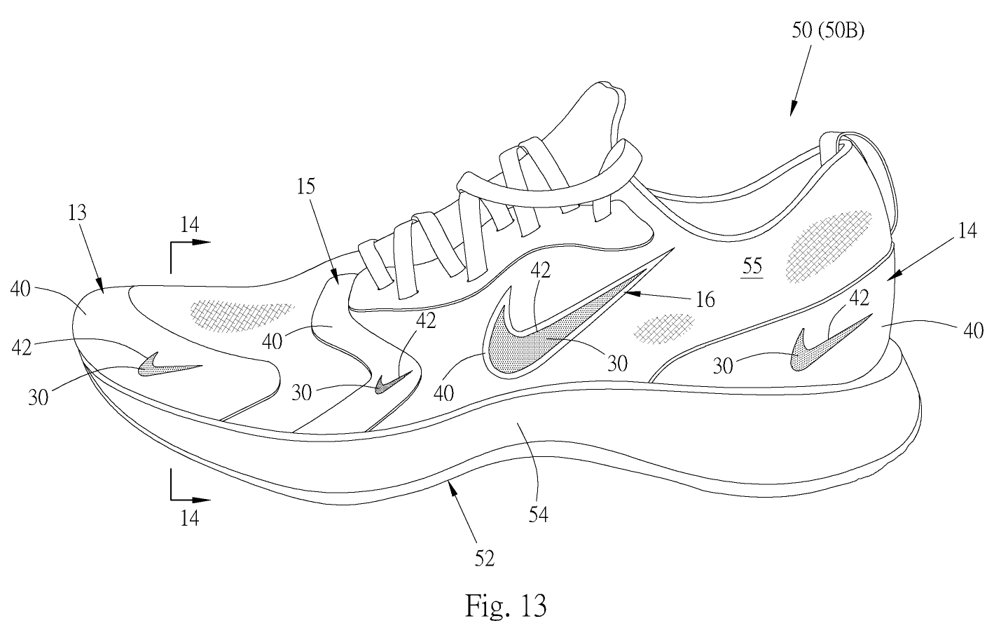

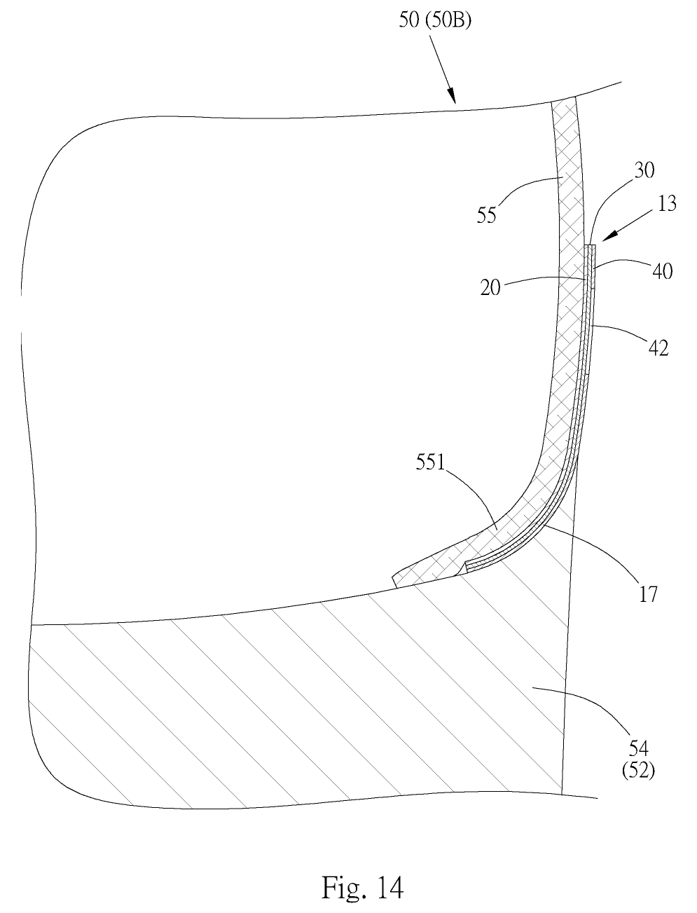

FIG. 13 shows the article 50 (50B) of another preferred embodiment of the invention. Taking a sports shoe 50B as an example, the sports shoe 50B has a sole 52 and a vamp 55 made of fabric or leather. An edge 551 of the vamp 55 is bonded to a midsole 54 of the sole 52, as shown in FIG. 14. A plurality of light-reflective sheets 13-16 are bonded on the vamp 55, including: the light-reflective sheet 13 bonded to a toe, the light-reflective sheet 14 bonded to a heel, and the light-reflective sheets 15, 16 bonded to a body of the shoe. The light-reflective sheets 13-16 can be the light-reflective sheets 12A or 12C shown in FIG. 11, and base layers thereof are the hot melt adhesive layers 20A, bonded to the vamps 55 with the hot melt adhesive layers 20A. The light-reflective sheets 13-16 can also be the light-reflective sheets 12B shown in FIG. 12, the base layers 20B thereof are non-adhesive and are adhered to the vamps 55 with the adhesive 26 as shown in FIG. 12.

The light-reflective sheets 13-16 are all two-tone, with the light-reflective layers 30 and the PU layers 40 thereof having different colors. The light-reflective patterns 42 of the light-reflective sheets 13-16 reflect light, providing safety for nighttime activities.

In this embodiment, the light-reflective sheets 13, 14, and 15 are structurally reinforcing and supportive light-reflective sheets, while the light-reflective sheet 16 on the shoe body is a decorative and aesthetic light-reflective sheet. The decorative light-reflective sheet 16 is simply disposed on the vamp 55 and does not support a structure of the sports shoe 50B, therefore, the light-reflective sheet with the base layer being the hot-melt adhesive layer can be used.

The supporting light-reflective sheets 13-15 are positioned to support and reinforce a structure of the sports shoe 50B. The light-reflective sheet, made with synthetic leather as the base material, possesses excellent toughness and strength to support the vamp (mesh fabric). As shown in FIG. 14, taking the light-reflective sheet 13 as an example from the light-reflective sheets 13-15, an edge 17 of a bottom side thereof is adhered to the edge 551 of the vamp 55 and the midsole 54 of the sole 52 with an adhesive. The base layer 20 of the light-reflective sheet 13 is bonded to the vamp 55, while the PU layer 40 is adhesively attached to the midsole 54 with an adhesive. A position where the PU layer 40 being adhesively attached to the midsole 54 remains intact, and the light-reflective pattern 42 or the light-reflective patterns 42 is/are disposed on parts that exposed on the sole. Similarly, bottom edges of the two light-reflective sheets 14, 15 are also adhesively attached between the edge 551 of the vamp and the midsole 54. In this way, the light-reflective sheets 13-15 enhance a structural strength of the toe, heel, and body of the sports shoe 50B. When the sports shoe 50B is in use, the sole 52, the vamp 55, and other parts will be subjected to pressing, pulling, and twisting, the light-reflective sheets 13-15 can withstand an acting force exerted by the sports shoe 50B and will not separate from the sports shoe 50B. The light-reflective film and light-reflective sheets of the invention are resistant to bending. The light-reflective sheet 15 is located where the sports shoe 50B undergoes the most bending and flexing. The light-reflective sheet 15 can withstand repeated bending of the sports shoe 50B, and the PU layer 40 and the light-reflective layer 30 thereof will not separate.

Because a peeling force between the PU layer 40 and the light-reflective layer 30 of the light-reflective sheets 13-15 is high (ranging from 3 to 15 kgf/1 inch width), the PU layer 40 and the light-reflective layer 30 cannot be easily peeled off. Therefore, the light-reflective sheets 13-15 can be directly adhered between the vamp and the midsole of the shoe without grinding off the light-reflective layer 30 on the bottom edge 17 of the light-reflective sheets 13-15. When the light-reflective sheet of the invention is adhered between the vamp 55 and the midsole 54, the vamp 55 and the midsole 54 maintain a stable bond. Conventional light-reflective materials described in the background of the invention cannot be adhered between the vamp and the midsole because their light-reflective elements have weak bonding force to any material and can be easily peeled off, causing the vamp and the midsole to easily separate. In order to adhere conventional light-reflective materials between the vamp and the midsole, light-reflective elements must be ground off to achieve a requirement.

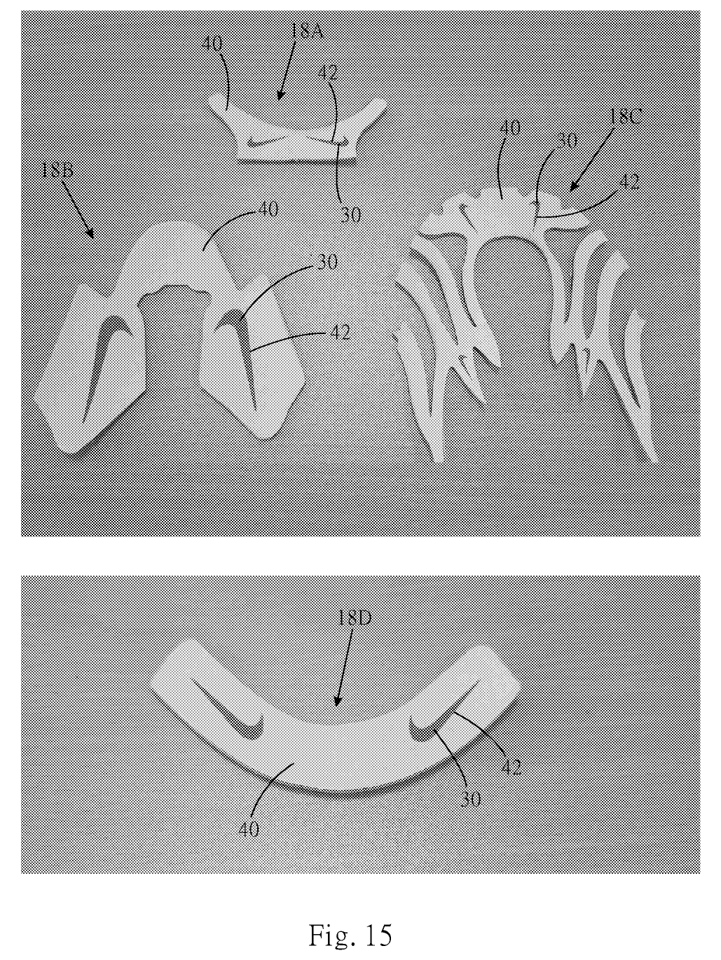

FIG. 15 illustrates a plurality of light-reflective sheets 18A-18D of different shapes, which can be formed by cutting the PU light-reflective film 10 (10A, 10B, 10C) of the first or second preferred embodiment. The light-reflective sheets 18A-18D can serve as decorative or supporting light-reflective sheets for the articles 50 (50A, 50B). The light-reflective sheets 18A-18D are configured with two colors, with the light-reflective layer 30 and the PU layer 40 thereof having different colors.

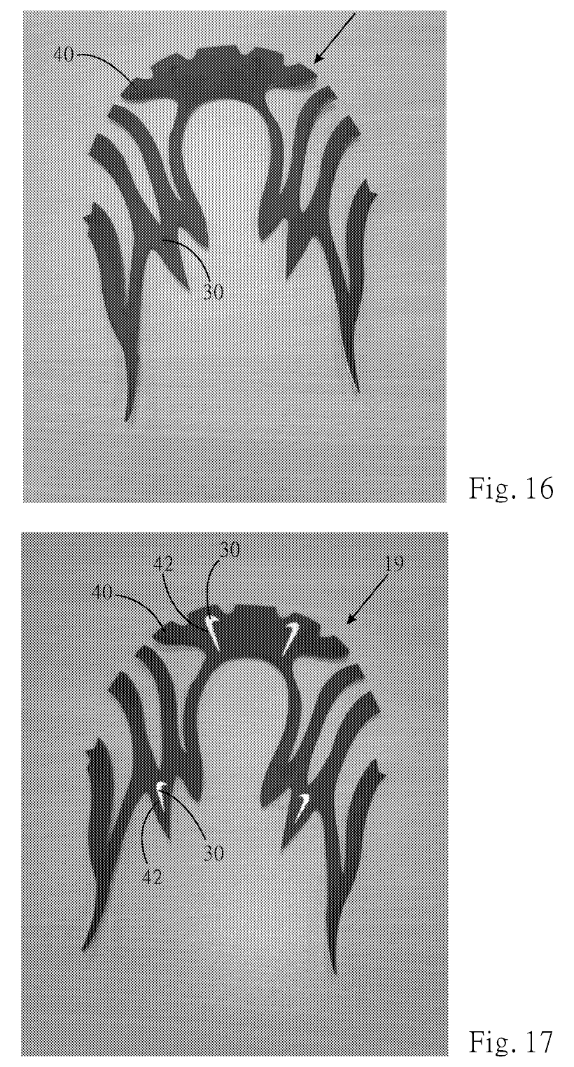

FIG. 16 shows a light-reflective sheet 19, which can be made from the PU light-reflective film 10 (10A, 10B, 10C) of the first or second preferred embodiment. Wherein the light-reflective layer 30 and the PU layer 40 are made of a same color. Therefore, the light-reflective pattern 42 is not easily visible in FIG. 16, as the light-reflective pattern 42 is hidden within the light-reflective sheet 19. When light shines on the light-reflective sheet 19, the light-reflective pattern 42 reflects the light, as shown in FIG. 17, making the light-reflective pattern 42 easily visible.

As shown in FIG. 14, the invention discloses the article 50 (50B) having a first element (the vamp 55) and a second element (the sole 52) joined together; the light-reflective sheet 13 is disposed between the first element (55) and the second element (52), the base layer 20 thereof being bonded to the first element (55), and the polyurethane layer 40 thereof being bonded to the second element (52), with only a part of the polyurethane layer 40 bonded to the second element (52), remaining parts of the polyurethane layer 40 are exposed to the second element (52), such that a light-reflective part (the light-reflective pattern 42) of the polyurethane layer 40 is exposed to the article 50 (50B).

The invention provides the PU light-reflective film and the light-reflective sheet. The light-reflective sheet is made by cutting or stamping the PU light-reflective film, therefore, both the light-reflective film and the light-reflective sheet have a surface layer (the PU layer) and the light-reflective layer. The light-reflective layer is an inner layer of the light-reflective film or the light-reflective sheet. By removing a part or parts of the surface layer, the light-reflective layer can be exposed, so that the part of the surface layer being removed becomes light-reflective part of the light-reflective film or the light-reflective sheet. At positions other than the light-reflective part, the light-reflective layer is still shielded by the surface layer and is not exposed.

The removed parts of the surface layer can be made into various shapes to create the light-reflective patterns. Therefore, the light-reflective film and the light-reflective sheet can be manufactured into the various light-reflective patterns as needed, enabling for flexible variations in a shape of the light-reflective patterns.

The polyurethane layer, which serves as the surface layer and the light-reflective layer can be made to have a same color or different colors. When the polyurethane layer and the light-reflective layer have different colors, the surface layer of the light-reflective film or the light-reflective sheet have a color different from that of the light-reflective pattern, creating a multi-colored design for the light-reflective film and the light-reflective sheet.

The polyurethane layer (the surface layer) can be made in various colors, with exteriors of different materials and textures, such as leather texture and exterior, or wood texture, stone texture, metal texture, leather texture, or fiber texture, to enhance an aesthetics of the light-reflective sheet and the article using the light-reflective sheet.

A strong bond between the polyurethane layer and the light-reflective layer makes it difficult to separate the polyurethane layer and the light-reflective layer, enabling the light-reflective sheet of the invention to serve as a reinforcing or supporting light-reflective sheet when disposed on parts of the article that bear an acting force. Because the polyurethane layer and the light-reflective layer cannot be easily separated, the light-reflective film and the light-reflective sheet of the invention can be used as adhesive objects between two articles (e.g., vamp and sole).

A strong bond between the polyurethane layer and the light-reflective layer ensures that the light-reflective film, the light-reflective sheet, and the article are washable and resistant to bending, and the polyurethane layer and the light-reflective layer will not detach. The polyurethane layer has excellent abrasion resistance, providing the light-reflective film and the light-reflective sheet with abrasion resistance.

Although the invention has been disclosed as above with the embodiments, they are not intended to limit the invention. A person having ordinary skill in the art to which the invention pertains can make various changes and modifications without departing from the spirit and scope of the invention. Therefore, the scope of protection of the invention shall be subject to what is defined in the pending claims.

What is claimed is:

1. A polyurethane light-reflective film comprising:
a base layer;
a light-reflective layer disposed on the base layer, the light-reflective layer having light-reflective elements; and
a polyurethane layer made of polyurethane or thermoplastic polyurethane material, the polyurethane layer being disposed on the light-reflective layer;
the polyurethane layer being removable, exposing the light-reflective layer at at least one position where at least one part of the polyurethane layer being removed.

2. The light-reflective film as claimed in claim 1, comprising:
at least one open part disposed on the polyurethane layer, formed by removing the polyurethane layer; the light-reflective layer being exposed to the at least one open part, forming at least one light-reflective part of the light-reflective film.

3. The light-reflective film as claimed in claim 2, wherein the at least one open part has a shape such that the light-reflective part forms at least one light-reflective pattern.

4. The light-reflective film as claimed in claim 1, wherein the light-reflective layer and the polyurethane layer have a same color or different colors.

5. The light-reflective film as claimed in claim 1, wherein a peeling force between the polyurethane layer and the light-reflective layer is between 3 and 15 kgf/1 inch width.

6. The light-reflective film as claimed in claim 1, wherein silane or/and acrylic acid is/are added to the polyurethane layer, and the polyurethane layer contacts the light-reflective elements of the light-reflective layer.

7. The light-reflective film as claimed in claim 1, wherein the polyurethane layer is formed by coating liquid polyurethane resin or thermoplastic polyurethane resin on the light-reflective layer and is bonded to the light-reflective layer.

8. The light-reflective film as claimed in claim 2, wherein one surface of the polyurethane layer is bonded to the light-reflective layer with an adhesive.

9. The light-reflective film as claimed in claim 8, wherein the adhesive is a polyurethane resin or an acrylic resin, and silane is added, and the adhesive contacts the light-reflective elements of the light-reflective layer.

10. The light-reflective film as claimed in claim 1, wherein the base layer is a material that is adhesive or non-adhesive and has flexibility.

11. The light-reflective film as claimed in claim 10, wherein the base layer is adhesive and is a hot melt adhesive layer; or the base layer is not adhesive and is made of leather, artificial leather, plastics or paper.

12. A light-reflective sheet comprising:
a base layer;
a light-reflective layer disposed on the base layer, the light-reflective layer having light-reflective elements; and
a polyurethane layer made of polyurethane or thermoplastic polyurethane material, the polyurethane layer being disposed on the light-reflective layer;
at least one open part disposed on the polyurethane layer; the light-reflective layer being exposed to the at least one open part, forming at least one light-reflective part of the light-reflective sheet.

13. The light-reflective sheet as claimed in claim 12, wherein the at least one open part has a shape such that the at least one light-reflective part forms at least one light-reflective pattern.

14. The light-reflective sheet as claimed in claim 12, wherein the light-reflective layer and the polyurethane layer have a same color or different colors.

15. The light-reflective sheet as claimed in claim 12, wherein a peeling force between the polyurethane layer and the light-reflective layer is between 3 and 15 kgf/1 inch width.

16. The light-reflective sheet as claimed in claim 12, wherein silane or/and acrylic acid is/are added to the polyurethane layer, and the polyurethane layer contacts the light-reflective elements of the light-reflective layer.

17. The light-reflective sheet as claimed in claim 12, wherein the polyurethane layer is formed by coating liquid polyurethane resin or thermoplastic polyurethane resin on the light-reflective layer and is bonded to the light-reflective layer.

18. The light-reflective sheet as claimed in claim 12, wherein one surface of the polyurethane layer is bonded to the light-reflective layer with an adhesive, the adhesive is a polyurethane resin or an acrylic resin, and silane is added therein, and the adhesive contacts the light-reflective elements of the light-reflective layer.

19. The light-reflective sheet as claimed in claim 13, wherein the light-reflective sheet has a contour shape; a shape of the at least one light-reflective pattern is the same as or different from the contour shape of the light-reflective sheet.

20. The light-reflective sheet as claimed in claim 12, wherein the base layer is a material that is adhesive or non-adhesive and has flexibility.

21. The light-reflective sheet as claimed in claim 12, wherein the base layer is adhesive and is a hot melt adhesive layer; or the base layer is not adhesive and is made of leather, artificial leather, plastics or paper.

22. An article having a light-reflective sheet, comprising:
at least one the light-reflective sheet as claimed in claim 12; and
an article, at least one the light-reflective sheet being disposed on the article, and the base layer being attached to the article.

23. The article as claimed in claim 22, wherein the article is a shoe having a sole and a vamp, an edge of the vamp is connected to the sole; a bottom edge of at least one the light-reflective sheet is disposed between the sole and the vamp, the base layer is connected to the vamp, the polyurethane layer is connected to the sole; at least one the light-reflective part is located at at least one position where the polyurethane layer is exposed on the sole.

24. The article as claimed in claim 22, wherein the article has a first element and a second element combined together; at least one the light-reflective sheet is disposed between the first element and the second element, and the at least one light-reflective part of at least one the light-reflective sheet is exposed on the article.
